(19) United States
(12) Patent Application Publication
(10) Pub. No.: US 2002/0164086 A1
(43) Pub. Date: Nov. 7, 2002

(54) Method of quantitative determination of an image drift in digital imaging microscope

(76) Inventors: Albert Sicignano, Mt. Kisco, NY (US); Dmitriy Yeremin, Dobbs Ferry, NY (US)

Correspondence Address: Ilya Zborovsky, 6 Schoolhouse Way, Dix Hills, NY, 11746, US

(21) Appl. No.: 09/848,655

(22) Filed: May 4, 2001

(51) Int. Cl. G06T 7/60; G01B 11/14; G06K 9/52

(52) U.S. Cl. 382/286; 356/620

(57) ABSTRACT

A method of quantitative determination of an image drift in a digital imaging microscope includes using a pattern which has a plurality of three-dimensional features spaced from one another into mutually perpendicular directions, producing a set of images of the pattern within certain time intervals therebetween, and determining an offset of each of the features in the set of the thusly obtained images as an image thrift.

### BACKGROUND OF THE INVENTION

The present invention relates to method of quantitative determination of an image drift in digital imaging microscope.

In the digital imaging microscopes an image drift can be caused by external parameters outside of the microscope, such as for example electric fields, vibrations, temperature changes, etc. It can be also caused by changes in power supply and voltages in the microscope which may affect either an electron gun, or the scanning mechanism, or the electromagnetic lenses. Finally, it can be also caused by a physical movement or drift of a stage on which the test object is mounted. It can be also related to the nature of interaction of electron beam with the sample, and a charge built on the sample. It is believed to be advisable to exactly quantitatively determine an image drift, so as to ultimately determine whether the microscope is acceptable or not for corresponding metrology processes.

### SUMMARY OF THE INVENTION

Accordingly, it is an object of the present invention to provide a method of quantitative determination of an image drift in digital imaging microscope.

In keeping with these objects and with others which will become apparent hereinafter, one feature of the present invention resides, briefly stated, in a method of quantitative determination of an image drift in digital imaging microscope, which includes using a pattern which has a plurality of three-dimensional features spaced from one another into mutually perpendicular directions; producing a set of two-dimensional images of the pattern with certain time intervals therebetween; and determining an offset of each of the features in set of the thusly obtained images so as to thereby determine an image drift.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a pattern of a test object which is utilized in an inventive method;

FIGS. 2 and 3 are views showing two different embodiments of features of the pattern for the inventive method;

FIG. 4 is a view showing a step of determining centers of the features of the pattern utilized in the inventive method;

FIG. 5 is a view showing the step of determining a center of all the centers of the features of the pattern used of the present invention; and

FIG. 6 is illustrating an image drift of a scanning image of an electron microscope determined in accordance with the present invention.

### DESCRIPTION OF THE PREFERRED EMBODIMENT

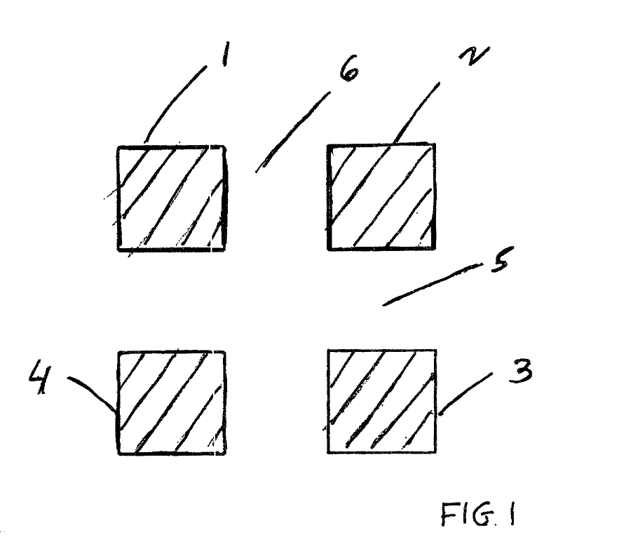

For quantitative determination of an image drift in a scanning microscope a pattern is utilized. A drift reference material is provided with the pattern shown in FIG. 1. The pattern includes a plurality of three-dimensional features which are identified with references numeral 1, 2, 3, 4. They can be square, round, etc. They are separated from one another by intervals 5 and 6. Two of the features are spaced from one another in one direction, for example in the vertical direction, while two other features are spaced from one another in another horizontal direction x so as to form preferably equal distances between the features.

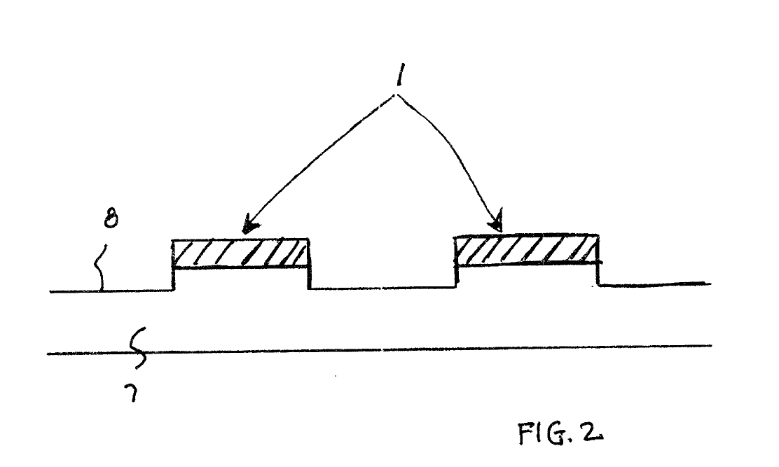

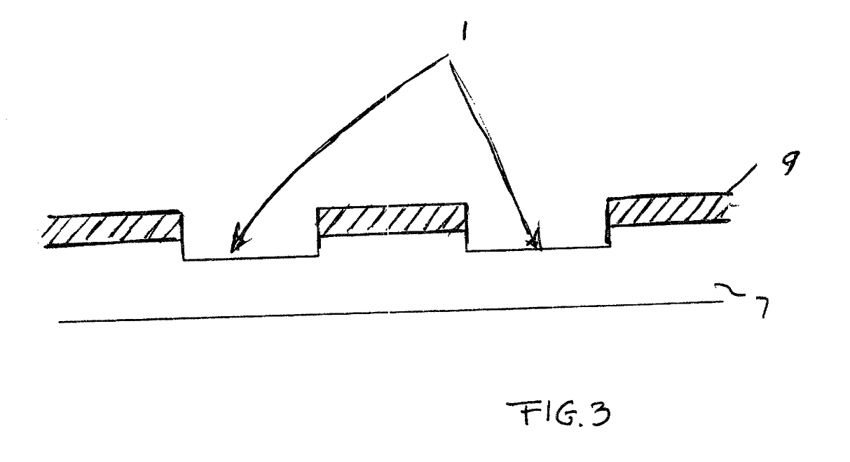

As shown in FIG. 2, the feature 1 is located above an adjacent surface 8 of the substrate 7. As shown in FIG. 3, the feature 1 is located below an adjacent surface 9 formed by a layer applied on the substrate 7.

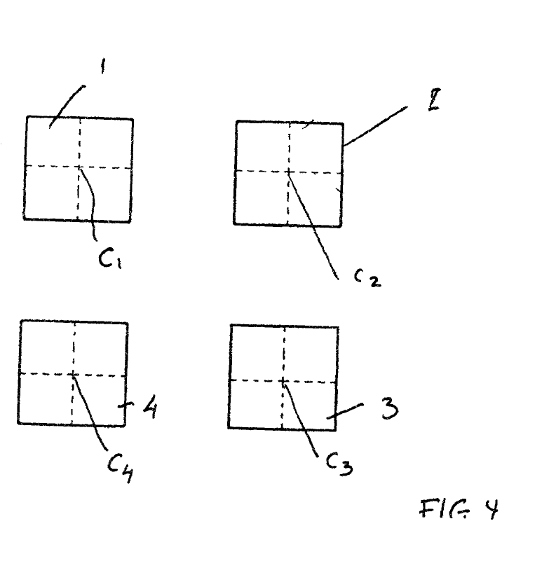

In accordance with the inventive method, a plurality of images of the pattern are formed by successive collection of a set of digital images of the pattern with a predetermined time interval between the formation of images. Then, a center of each feature of each pattern is determined in each image, as shown in FIG. 4. An offset of the center of each feature in the set of the images along a corresponding direction or axis determines an image drift. This step can be used for determining an image drift and also for determining a rotation of the image from one time interval to another.

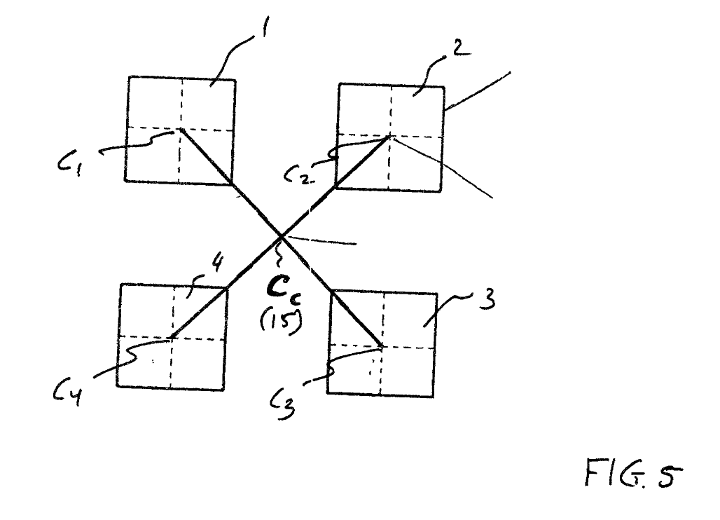

In order to more accurately determine a drift, in accordance with a further step shown in FIG. 5, a central point between the centers of the features is determined for each image, and thereafter an offset of the central points from one image of the pattern to the other is determined. This offset of the central point determines an image drift.

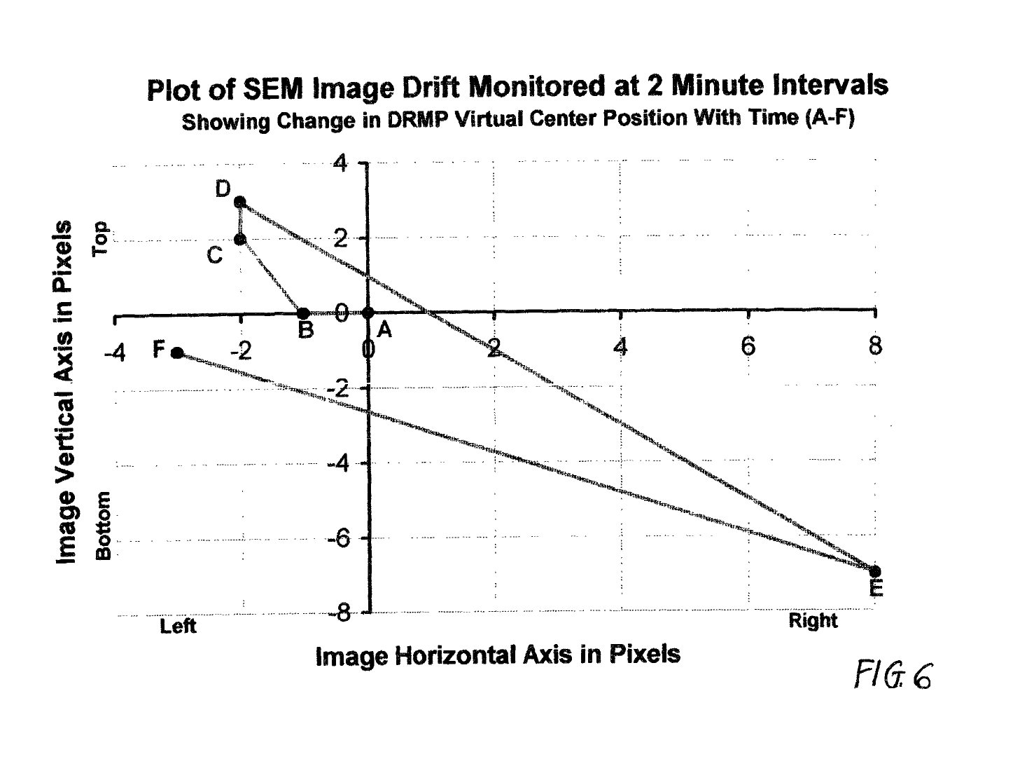

FIG. 6 shows an image drift in an X-Y coordinate system, in which points A, B, C, D, E, F, represent a position of the central point 15 in the images formed through corresponding time intervals. The location of the central points can be identified in pixels, or in the linear units of measurements, for example in nanometers. Furthermore, the central points can be identified with sub pixel accuracy greater than 0.01 pixel.

Based on the thusly determined image drift, a user of the scanning electron microscope determines whether it is suitable for corresponding metrology operations or not. This determination can be based on whether the thusly determined drift is within a predetermined quantitative limit, whether it is within a predetermined time period, etc. The method also shows whether the image drift is linear, whether it decreases or increases in time, or whether it is a random drift or it has a specific character, such as an oscillating nature, a circular drift, etc. Based on the nature of the drift, it is also possible to determine a cause or source of each specific image drift.

In accordance with the invention, a plurality of patterns can be provided, which differ from one another by a size of the features and a magnitude of spaces between the features. In beginning of the process a user selects a range of measurements on the microscope, for example any range between a minimum (10 nanometers) or a maximum (1 micron). A software utilized in the method will use the information about the selected range to select a corresponding pattern with a corresponding size of the features and a corresponding value of a space between the features. Also, a pattern with a corresponding size of the features and value of the space can be selected by a software in dependence on a maximum drift allowed by a user.

At the final stage of the process, the software can store the values of the drift, can indicate them on a display, and provide an answer whether the drift is acceptable or not, etc. A graphical representation can be provided as well.

It will be understood that each of the elements described above, or two or more together, may also find a useful application in other types of constructions differing from the types described above.

While the invention has been illustrated and described as embodied in method of quantitative determination of an image drift in digital imaging microscope, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of quantitative determination of an image drift in a digital imaging microscope, comprising the steps of using a pattern which has a plurality of features spaced from one another into mutually perpendicular directions; producing a set of images of the pattern with certain time intervals therebetween; and determining an offset of each of the features in the set of the thusly obtained images as an image drift.

2. A method as defined in claim 1; and further comprising using the pattern which includes four said features, which two of the features spaced in one direction and two of the features spaced in a perpendicular direction.

3. A method as defined in claim 1; and further comprising determining a center of each feature, said determining an offset includes determining an offset of said center of each of said features in said set of images of said pattern.

4. A method as defined in claim 1, wherein said determining an offset includes determining a center of each of said features and then determining a central point between said centers of said features, said determining of an offset includes determining an offset of said central points in said set of images.

5. A method as defined in claim 3, wherein said determining an offset the centers of the features is performed in two mutually perpendicular directions.

6. A method as defined in claim 2, wherein said determining of an offset of said centers of said features is performed so as to determine turning of said centers of said features.

7. A method as defined in claim 1; and further comprising providing a plurality of patterns which are different from one another by at least one parameter selected from the group consisting of a size of each feature and a magnitude of a space between the features, and selecting a pattern in correspondence with a size range of measurements to be performed by a scanning electron microscope.

8. A method as defined in claim 1; and further comprising providing a plurality of patterns which are different from one another by at least one parameter selected from the group consisting of a size of each feature and a magnitude of a space between the features, and selecting a pattern in correspondence of a drift acceptable by a user of the scanning electron microscope.

9. A method as defined in claim 1; and further comprising a step of representing the thusly determined image drift graphically on a display screen.

10. A method as defined in claim 1; and further comprising representing the thusly determined image drift in a digital form.

11. A method as defined in claim 1; and further comprisign comparing the thusly determined drift with a predetermined image drift threshold; and providing an answer whether the scanning electron microscope with the thusly determined drift can be utilized or not for metrology purposes.
